(19) United States
(12) Patent Application Publication
(10) Pub. No.: US 2007/0166478 A1
(43) Pub. Date: Jul. 19, 2007

(54) Thermal spray powder and process for producing the same as well as method for spraying the same

(76) Inventors: Tsuyoshi Itsukaichi, Nishikasugai-gun (JP); Satoru Osawa, Nishikasugai-gun (JP); Isao Aoki, Nishikasugai-gun (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/717,369

(22) Filed: Mar. 13, 2007

Related U.S. Application Data
(62) Division of application No. 10/673,769, filed on Sep. 29, 2003, now abandoned.

(30) Foreign Application Priority Data
Sep. 30, 2002 (JP) 2002-287170

(51) Int. Cl. B05D 1/08

(52) U.S. Cl. 427/446

(57) ABSTRACT

A thermal spray powder of the present invention includes particles composed of molybdenum disulfide, and a coating layer provided on the surface of each of the particles. The coating layer is composed of a metal that is softened or melted at a temperature lower than the heat decomposition temperature of the molybdenum disulfide. The coating layer is preferably composed of copper. The thermal spray powder suppresses heat decomposition of the molybdenum disulfide contained in the thermal spray powder during thermal spraying.

### BACKGROUND OF THE INVENTION

The present invention relates to a powder used as a thermal spraying material for forming a thermally sprayed coating containing molybdenum disulfide, a process for producing the powder, and a method for thermal spraying the powder.

Molybdenum disulfide has excellent sliding properties; therefore it is used as a solid lubricating material. Japanese Laid-open Patent Publication No. 2002-121576 discloses a method for forming a coating containing molybdenum disulfide, in which a slurry is applied having molybdenum disulfide dispersed-in an appropriate liquid. However, the resulting coating is thin, therefore the coating has a short life, which requires frequent maintenance, such as repeated applications.

By contrast, a thermally sprayed coating has a relatively large thickness. Therefore, thermal spraying is a promising means for forming a coating containing molybdenum disulfide having excellent durability. However, molybdenum disulfide suffers heat decomposition at high temperatures, therefore in order to obtain a sprayed coating containing molybdenum disulfide, it is necessary to take certain measures to prevent molybdenum disulfide from undergoing heat decomposition during the thermal spraying.

### SUMMARY OF THE INVENTION

Accordingly, it is an objective of the present invention to provide a thermal spray powder that can suppress heat decomposition of molybdenum disulfide contained in the powder during thermal spraying, a process for producing the powder, and a method for thermal spraying the powder.

To achieve the above objective, the present invention provides a thermal spray powder, which includes particles and a coating layer provided on a surface of each of the particles. The particles are composed of molybdenum disulfide. The coating layer is composed of a metal that is softened or melted at a temperature lower than the heat decomposition temperature of the molybdenum disulfide.

The present invention also provides a process for producing a thermal spray powder. The process includes preparing particles composed of molybdenum disulfide, and providing a coating layer on a surface of each of the particles by an electroless plating method. The coating layer is composed of a metal that is softened or melted at a temperature lower than the heat decomposition temperature of the molybdenum disulfide.

The present invention provides another process for producing a thermal spray powder. The process includes preparing particles composed of molybdenum disulfide, and providing a coating layer composed of copper on a surface of each of the particles by an electroless plating method.

The present invention further provides a method for spraying a thermal spray powder. The method includes preparing the thermal spray powder, and feeding the thermal spray powder to a flame in order to soften or melt the thermal spray powder. The thermal spray powder includes particles composed of molybdenum disulfide, and a coating layer provided on a surface of each of the particles. The coating layer is composed of a metal that is softened or melted at a temperature lower than the heat decomposition temperature of the molybdenum disulfide. A cylindrical air stream passes around the flame. The thermal spray powder fed to the flame passes through the inside of the air stream to be softened or melted in the inside of the air-stream, and the powder is subsequently sprayed onto a substrate.

Other aspects and advantages of the invention will become apparent from the following description, taken in conjunction with the accompanying drawings, illustrating by way of example the principles of the invention.

### BRIEF DESCRIPTION OF THE DRAWING

The invention, together with objects and advantages thereof, may best be understood by reference to the following description of the presently preferred embodiments together with the accompanying drawings, in which:

FIG. 1 is a cross-sectional view of a high-velocity flame spraying machine suitable for spraying a thermal spray powder according to one embodiment of the present invention.

### DETAILED DESCRIPTION OF THE PREFERRED EMBODIMENTS

One embodiment of the present invention will be described below.

A thermal spray powder according to this embodiment includes molybdenum disulfide particles, each having a coating layer composed of copper provided on the surface. It is preferred that the coating layer is formed by an electroless plating method on the surface of each molybdenum disulfide particle.

The particle size distribution of the thermal spray powder is appropriately adjusted, depending on the type of a spraying machine used in the spraying or the spraying conditions; for example, 5 to 75 μm, 10 to 45 μm, 15 to 45 μm, 20 to 63 μm, or 25 to 75 μm. Preferred particle size distribution is 5 to 75 μm.

The lower limit of the particle size distribution is a value measured by means of a laser diffraction type particle size meter, e.g., “LA-300,” manufactured by HORIBA, Ltd., wherein the percentage of particles having a particle size of such a value or smaller contained in the thermal spray powder is no more than 5%. The upper limit of the particle size distribution is a value measured by means of a rotating and tapping type tester wherein the percentage of particles having a particle size of such a value or larger contained in the thermal spray powder is no more than 5%. For example, when the particle size distribution of a thermal spray powder is 5 to 75 μm, the thermal spray powder contains no more than 5% of particles having a particle size of no more than 5 μm, as measured by a laser diffraction type particle size meter, and no more than 5% of particles having a particle size of at least 75 μm, as measured by a rotating and tapping type tester.

The content of molybdenum disulfide in the thermal spray powder is preferably 30% to 90% by weight, more preferably 40% to 80% by weight. The content of copper in the thermal spray powder is preferably 10% to 70% by weight, more preferably 20% to 60% by weight.

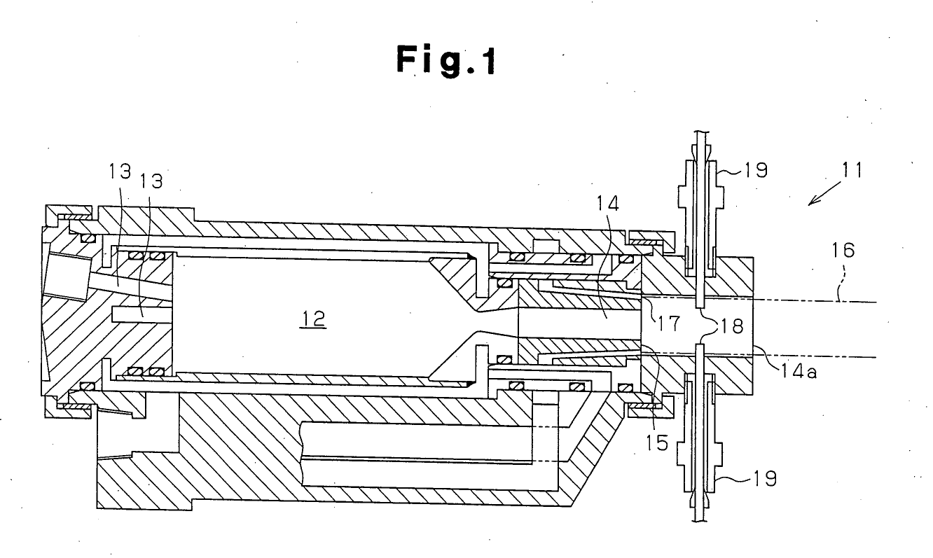

When the thermal spray powder according to this embodiment is sprayed, it is preferred to use a high-velocity flame spraying machine 11, shown in FIG. 1 as an example. Among commercially available high-velocity flame spraying machines, preferred is, for example, “θ-Gun” (trade name), manufactured by WHITCO JAPAN.

The spraying machine 11 shown in FIG. 1 will be described below.

The spraying machine 11 softens or melts the thermal spray powder using flame at a high temperature under a high pressure generated upon combustion of a fuel and oxygen, and sprayes the powder. The spraying machine 11 has a combustion chamber 12 in which a fuel and oxygen combust. A first passage 13, which is in communication with the combustion chamber 12 and is open to the outside at the rear end (left-hand end in FIG. 1) of the spraying machine 11, introduces a fuel and oxygen into the combustion chamber 12. A second passage 14, which is in communication with the combustion chamber 12 and is open to the outside at the front end (right-hand end in FIG. 1) of the spraying machine 11, feeds flame generated in the combustion chamber 12 out of the spraying machine 11. The flame flows through the second passage 14 and is discharged through a discharge port 14a at the front end (right-hand end in FIG. 1) of the second passage 14.

Provided halfway along the second passage 14 is a step face 15 facing downstream of the second passage 14. The step face 15 is provided with injection ports 17, through which a cylindrical air stream 16 is injected toward the discharge port 14a. The flame flowing through the second passage 14 toward the discharge port 14a passes through the inside of the cylindrical air stream 16 injected from the injection ports 17.

A portion of the second passage 14 between the step face 15 and the discharge port 14a is provided with a pair of powder feeding portions 18. The powder feeding portions 18 are openings at the downstream ends of connecting pipes 19 extending from a powder feeder not shown. The powder feeding portions 18 feed the thermal spray powder to the flame flowing through the inside of the cylindrical air stream 16. Therefore, the fed thermal spray powder is softened or melted by the flame in the cylindrical air stream 16 to be sprayed onto a substrate.

The embodiment of the present invention provides the following advantages.

Copper constituting the coating layer of the thermal spray powder is softened at a temperature lower than the heat decomposition temperature of molybdenum disulfide (about 750° C.). For this reason, when the thermal spray powder is sprayed at no more than the heat decomposition temperature of molybdenum disulfide, and at least the softening temperature of copper, a sprayed coating containing molybdenum disulfide. that has not undergone heat decomposition is formed from the thermal spray powder. The sprayed coating has excellent sliding properties based on molybdenum disulfide.

The thermal spraying makes it easy to form a coating having a large thickness. A sprayed coating formed so as to have a large thickness has high durability.

When the lower limit of the particle size distribution of the thermal spray powder is at least 5 μm, a failure is prevented due to a large amount of particles having an excessively small size contained in the thermal spray powder, for example, which would have lowered the deposition efficiency caused when the thermal spray powder is not reliably fed to flame.

When the upper limit of the particle size distribution of the thermal spray powder is no more than 75 μm, a failure is prevented due to a large amount of particles having an excessively large size contained in the thermal spray powder, for example, which would have lowered the deposition efficiency caused when the thermal spray powder is difficult to be softened or melted.

A thermally sprayed coating having satisfactory solid lubricating properties can be formed from the thermal spray powder when the content of molybdenum disulfide in the thermal spray powder is at least 30% by weight, or when the content of copper in the thermal spray powder is no more than 70% by weight.

A thermally sprayed coating having excellent adhesion properties and excellent toughness can be formed from the thermal spray powder when the content of molybdenum disulfide in the thermal spray powder is no more than 90% by weight, or when the content of copper in the thermal spray powder is at least 10% by weight.

Molybdenum disulfide of the thermal spray powder is not heated to its heat decomposition temperature or higher to undergo heat decomposition in forming the coating layer when the coating layer is formed by an electroless plating method. By contrast, when it is attempted to form a compound of molybdenum disulfide and copper by a agglomeration-sintering method, a sintering-crushing method, or a fusing-crushing method, which has conventionally been used for forming a compound of ceramics and metals, molybdenum disulfide undergoes heat decomposition during the sintering or fusing, so that a compound of molybdenum, sulfur, and copper will be formed instead of the compound of molybdenum disulfide and copper.

The high-velocity flame spraying machine 11 shown in FIG. 1 has the cylindrical air stream 16 in place of an injection nozzle that a typical high-velocity flame spraying machine commonly has, and therefore has no injection nozzle. For this reason, the spraying machine 11 shown in FIG. 1 can more freely be arranged with respect to a substrate against which the soften or melted thermal spray powder impinges, as compared to typical spraying machines having an injection nozzle. As the spraying machine 11 is positioned closer to the substrate, the residence time of the thermal spray powder in flame will be shorter, with the result that heat decomposition of molybdenum disulfide due to excessive heating of the thermal spray powder is suppressed.

It should be apparent to those skilled in the art that the present invention may be embodied in many other specific forms without departing from the spirit or scope of the invention. Particularly, it should be understood that the invention may be embodied in the following forms.

The coating layer may be composed of a metal other than copper, as long as the metal is softened or melted at a temperature lower than the heat decomposition temperature of molybdenum disulfide. Examples of such metals include zinc, aluminum, nickel, and alloys thereof, and copper alloys.

The coating layer may be formed by a method other than the electroless plating method.

The coating layer may be formed either on the entire surface of the molybdenum disulfide particles or on part of the surface of the molybdenum disulfide particles.

Oxygen to be fed to the combustion chamber 12 through first passage 13 may be replaced by air. Specifically, the spraying machine 11 may soften or melt the thermal spray powder using flame at a high temperature under a high pressure generated upon combustion of a fuel and air, instead of combustion of a fuel and oxygen, to inject the thermal spray powder.

Next, the present invention will be described in more detail with reference to the following Examples and Comparative Examples.

### EXAMPLE 1

A coating layer composed of copper was formed on the surface of each molybdenum disulfide particle by an electroless plating method to prepare powder.

### COMPARATIVE EXAMPLE 1

A mixture of molybdenum disulfide and copper was heat-melted and then cooled, and the resultant solid material was mechanically crushed to prepare a powder. That is, a powder was prepared from molybdenum disulfide and copper by a fusing-crushing method.

### COMPARATIVE EXAMPLE 2

A mixture of a molybdenum disulfide powder and a copper powder was sintered, and the-resultant sintered material was mechanically crushed to prepare a powder. That is, a powder was prepared from molybdenum disulfide and copper by a fusing-crushing method.

### COMPARATIVE EXAMPLE 3

Particles formed from a slurry comprising a molybdenum disulfide powder and a copper powder by an spray-drying agglomeration method were sintered together, and then crushed to prepare a powder. That is, a powder was prepared from molybdenum disulfide and copper by a agglomeration-sintering method.

The powder obtained in Example 1 was sprayed using a high-velocity flame spraying machine, “θ-Gun,” manufactured by WHITCO JAPAN to obtain a sprayed coating comprising molybdenum disulfide particles dispersed in a binding phase composed of copper.

On the other hand, when the powder obtained in Example 1 was sprayed using a high-velocity flame spraying machine, “JP-5000,” manufactured by PRAXAIR/TAFA, a sprayed coating composed mainly of a copper oxide and a compound of molybdenum, sulfur, and copper was obtained, with only a slight amount of molybdenum disulfide found in the sprayed coatings. Presumably, the reason for this is that copper was oxidized during the thermal spraying, and molybdenum disulfide underwent heat decomposition during thermal spraying, and then was reacted with copper.

When the powders obtained in Comparative Examples 1 to 3 were individually sprayed using “θ-Gun,” sprayed coatings composed mainly of a copper oxide and a compound of molybdenum, sulfur, and copper were obtained, with no molybdenum disulfide found in the sprayed coatings. The powders obtained in Comparative Examples 1 to 3 were examined, to find out that the particles constituting each powder were composed of a compound of molybdenum, sulfur, and copper, and contained no molybdenum disulfide. Therefore, it is presumed that molybdenum disulfide underwent heat decomposition in the process of the preparation of the powder and then it was reacted with copper.

The thermal sprayings using “θ-Gun” were conducted under the following thermal spraying conditions.

Oxygen flow rate: 1,900 scfh (893 1/min)

Kerosine flow rate: 5.1 gph (0.32 1/min)

Spray distance (distance between the powder feeding

portion and the substrate surface): 350 mm

Spray powder feed rate: 30 g/min

The thermal sprayings using “JP-5000” were conducted under the following thermal spraying conditions.

Oxygen flow rate: 1,900 scfh (893 1/min)

Kerosine flow rate: 5.1 gph (0.32 1/min)

Spray distance (distance between the spray gun nozzle tip

and the substrate surface): 380 mm

Nozzle length: 4 inches (about 100 mm)

Spray powder feed rate: 30 g/min

For the evaluation of the sprayed coatings obtained by thermal spraying the powders in the Examples, an X-ray diffractometer, “RINT-2000,” manufactured by Rigaku Corporation, was used.

The present examples and embodiments are to be considered as illustrative and not restrictive, and the invention is not to be limited to the details given herein, but may be modified within the scope and equivalence of the appended claims.

1. (canceled)

2. The method according to claim 10, wherein the coating layer is provided on the entire surface of the each particle.

3. The method according to claim 10, wherein the content of the molybdenum disulfide in the thermal spray powder is 30% to 90% by weight, and the content of the metal in the thermal spray powder is 10% to 70% by weight.

4. The method according to claim 3, wherein the content of the molybdenum disulfide is 40% to 80% by weight, and the content of the metal is 20% to 60% by weight.

5. The method according to claim 10, wherein the metal is copper.

6. The method thermal spray powder according to claim 5, wherein the content of the molybdenum disulfide in the thermal spray powder is 30% to 90% by weight, and the content of the copper in the thermal spray powder is 10% to 70% by weight.

7. The method according to claim 6, wherein the content of the molybdenum disulfide is 40% to 80% by weight, and the content of the copper is 20% to 60% by weight.

8. The method according to claim 10, said preparing the thermal spraying powder includes providing the coating layer by an electroless plating method.

9. (canceled)

10. A method for forming a thermally sprayed coating containing molybdenum disulfide, the method comprising:
preparing a thermal spray powder, wherein the thermal spray powder includes:
particles composed of molybdenum disulfide; and
a coating layer provided on a surface of each of the particles, wherein the coating layer is composed of a metal that is softened or melted at a temperature lower than the heat decomposition temperature of the molybdenum disulfide; and
thermal spraying the thermal spray powder, using a high-velocity flame spraying machine, at a temperature less than the heat decomposition temperature of molybdenum disulfide and not less than the softening or melting temperature of the metal composing the coating layer to form the thermally sprayed coating.

11. (canceled)
